(19) United States
(12) Patent Application Publication
(10) Pub. No.: US 2012/0235958 A1
(43) Pub. Date: Sep. 20, 2012

(54) CHIP CARD DISPLAY SYSTEM

(75) Inventors: Ming-Li CHEN, Kaohsiung (TW); Chien-Chih LIN, Kaohsiung (TW); Sheng-Han TSAI, Kaohsiung (TW); Kun-Ze WU, Kaohsiung (TW)

(73) Assignee: INNOVISION FLEXTECH CORPORATION, Kaohsiung (TW)

(21) Appl. No.: 13/049,956

(22) Filed: Mar. 17, 2011

(51) Int. Cl. G09G 5/00; G06K 19/073

(52) U.S. Cl. 345/204; 235/492

(57) ABSTRACT

A sheet of piezoelectric material is configured in a chip card; alternating current (AC) is generated through bending the piezoelectric material back and forth, the alternating current (AC) is then rectified into direct current (DC) to energize the chip card display system to display stored information.

### BACKGROUND

1. Technical Field

The present invention relates to a chip card display system, especially to a chip card having a display system energized by a build-in self power generator.

2. Description of Related Art

Due to technology progressive, a lot of chip cards such as credit cards, monetary cards, telephone cards, transportation cards, or cash cards . . . etc. have already been used as payment tools in these business transactions. Generally speaking, there are two categories for the various cards:

(1) a card embedded with a microprocessor chip and a security access module (SAM) to have a management function, this kind of card is also called a Smart Card; and
(2) a card embedded with a memory and a simple logic circuit, the memory to be used is a read only memory (ROM) or Electrically-Erasable Programmable Read-Only Memory (EEPROM), this kind of card is also called a Memory Card.

However, a “chip card” is collectively called for either a smart card or a memory card because an Integrated circuit (IC) chip is embedded inside each of the cards. The inconvenience for such a traditional card is that when the card holder wants to know the stored information, for example, the accumulate amount for a credit card being swiped, or the available cash amount in a cash card, the card holder shall have to go to find an exterior card reader to decrypt the stored information in the card and to retrieve the stored information through a display mounted on the card reader.

The inventor of this invention firstly thinks about that it shall be quite convenient for a card holder to know the stored information if a display is configured on the chip card itself and which shall display the stored information at anytime when the card holder wants to know, and even better if there is no need to install a traditional battery in the card.

FIGS. 1A˜1B show prior arts

FIG. 1A is a contact type chip card 101, e.g. a VISA card, which has an embedded chip 103. FIG. 1B is a non-contact type card 12 also called an induced card, e.g. a transportation card.

FIGS. 2A˜2B show section views along line AA′ of FIGS. 1A˜1B

FIG. 2A shows a VISA card 101, which has an embedded chip 103. A top surface of the chip 103 exposes out of the card 103 for a card reader to retrieve the stored information in the chip 103.

FIG. 2B shows an induction type card 102, which has an embedded chip 104, and an induction coil 105 electrically coupling to the chip 104. The stored information in the chip 104 can be retrieved by an exterior card reader through induction.

### BRIEF DESCRIPTION OF THE DRAWINGS

FIGS. 1A˜1B show prior arts

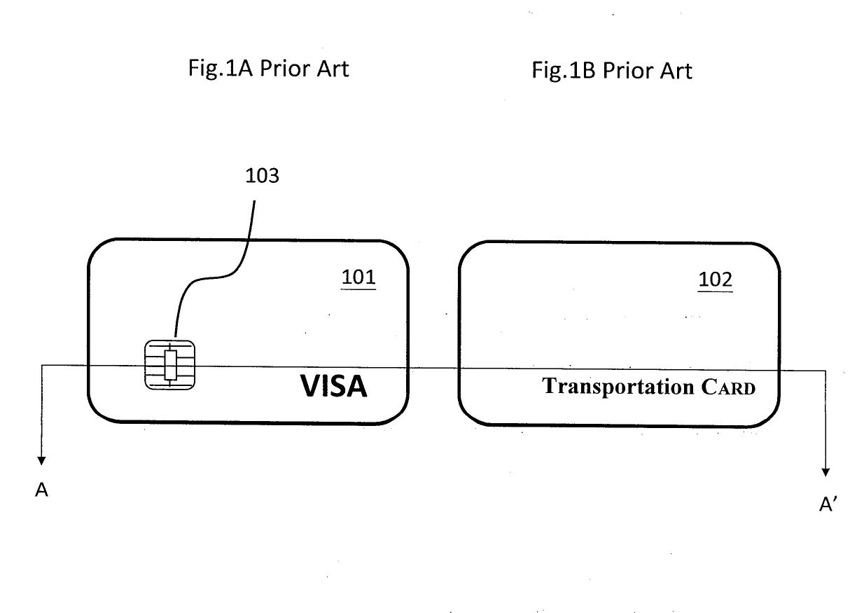

FIGS. 2A˜2B show section views along line AA′ of FIGS. 1A˜1B

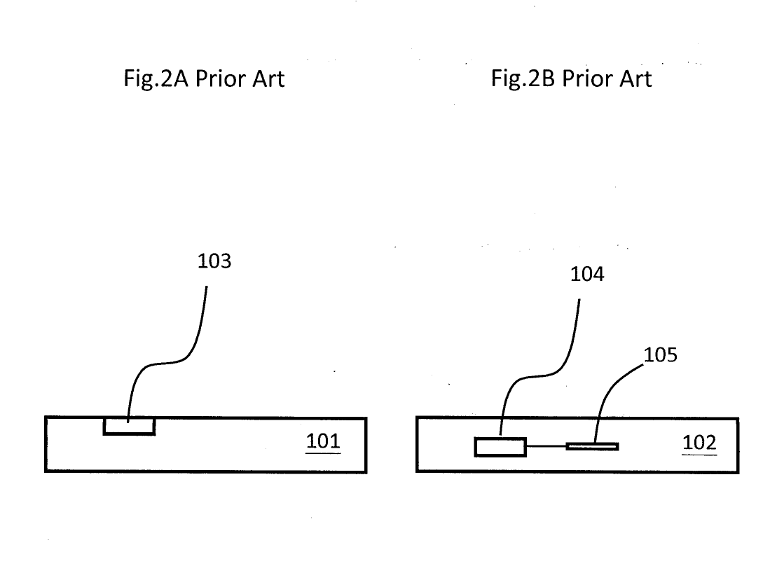

FIGS. 3A˜3B show top views of the first embodiment according to the present invention.

FIG. 4 shows a section view of either FIG. 3A or FIG. 3B

FIG. 5 shows another section view of either FIG. 3A or FIG. 3B

FIG. 6 shows power generating according to the present invention

FIGS. 7A˜7B shows information displayed on a display unit of the card.

FIG. 8 shows a second self power unit according to the present invention.

FIG. 9 shows a third self power unit according to the present invention.

FIG. 10 shows a fourth self power unit according to the present invention.

FIG. 11 shows a depressed status of the self power unit according to the present invention.

FIG. 12 shows a circuit block diagram for a first display system according to the present invention.

FIG. 13 shows a circuit block diagram for a second display system according to the present invention.

FIG. 14 shows a circuit block diagram for a third display system according to the present invention.

FIG. 15 shows a circuit block diagram for a first self power unit according to the present invention.

FIG. 16 shows a circuit block diagram for a second self power unit according to the present invention.

FIG. 17 shows a modified circuit to the second self power unit according to the present invention.

FIG. 18 shows a circuit block diagram for a third self power unit according to the present invention.

FIG. 19 shows a circuit block diagram for a fourth self power unit according to the present invention.

FIG. 20 shows a logic block diagram for a first chip card display system according to the present invention.

FIG. 21 shows a logic block diagram for a second chip card display system according to the present invention.

### DETAILED DESCRIPTION OF THE INVENTION

This invention discloses a chip card display system where a display is configured on the top surface of the chip card for displaying stored information. A self power unit is designed in the card to supply electric energy to the display system. The card holder can check the stored information of the card at any time at any place without using an outside card reader. The key feature of this invention focuses on the embedded self power unit, no traditional battery is needed to install in the card. The power energy needed for running the display system is supplied by a self power unit installed inside the card. A sheet of piezoelectric material is used to generate alternating current (AC) through bending back and forth. The piezoelectric material is bended back and forth through hands of manpower or through resonant vibration caused by mechanical forces, e.g. ultrasonic, to generate alternating current (AC). The alternating current is then converted to direct current (DC) through a rectifier circuit which can be either a half-wave rectification circuit or a full-wave rectification circuit.

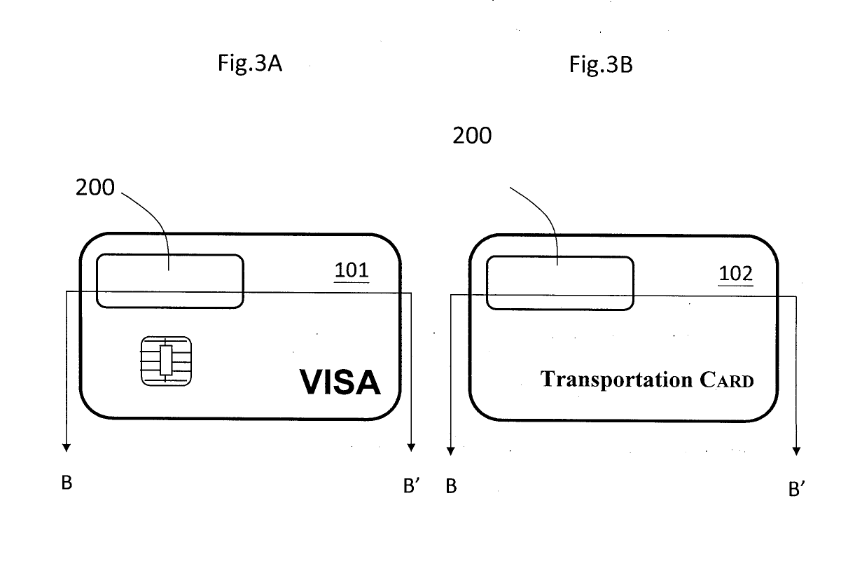

FIGS. 3A˜3B show top views of the first embodiment according to the present invention.

FIG. 3A shows a display unit 200 configured on the top of a contact type chip card 101 to display the stored information of the card 101.

FIG. 3B shows a display unit 200 configured on top of a non-contact type chip card 102 to display the stored information of the card 102.

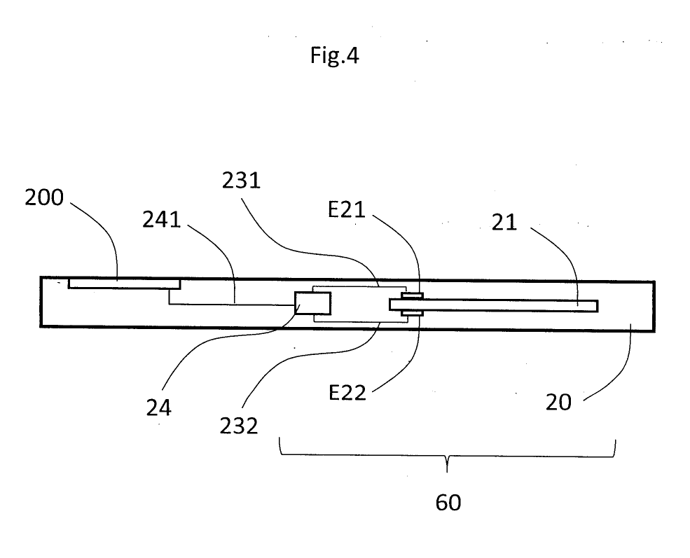

FIG. 4 shows a section view of either FIG. 3A or FIG. 3B

FIG. 4 shows a chip card display system having a first self power unit 60. A display unit 200 is configured in the chip card 20 and exposes its top surface out of the chip card 20 for displaying. A rectifier unit 24 electrically couples to the display unit 200 through a circuit 241 to convert alternating current to direct current for output. A sheet of piezoelectric material 21 has a top electrode E21 and a bottom electrode E22. The top electrode E21 electrically couples to a first end of the rectifier unit 24 through a circuit 231, and the bottom electrode E22 electrically coupling to a second end of the rectifier unit 24 through a circuit 232. The sheet of piezoelectric material 21 combing with the rectifier unit 24 forms the first self power unit 60 of the present invention.

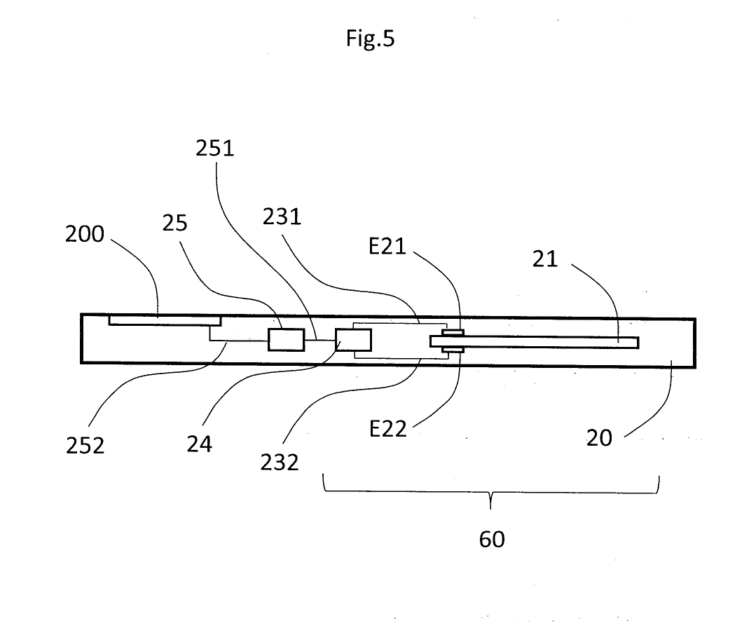

FIG. 5 shows another section view of either FIG. 3A or FIG. 3B

The chip card display system of FIG. 5 is similar to that shown in FIG. 4. The difference is that FIG. 5 further includes a control unit 25 configured in between the display unit 200 and the rectifier unit 24. The control unit 25 has a first end electrically coupling to the display unit 200, and has a second end electrically coupling to the rectifier unit 24. The control unit 25 determines whether or not to trigger the display unit 200 to display an information according to predetermined rules.

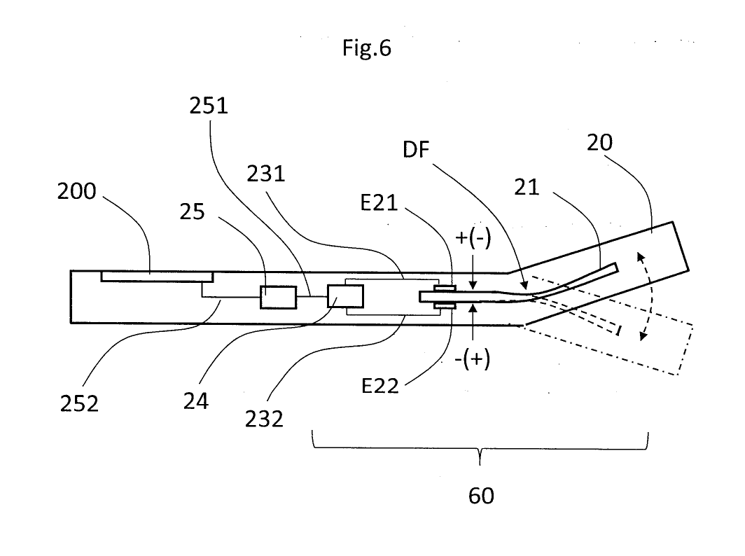

FIG. 6 shows power generating according to the present invention

FIG. 6 shows how the power energy is generated through the self power unit 60 according to the present invention. An AC voltage difference arises between top electrode E21 and bottom electrode E22 when the embedded piezoelectric material 21 deforms through bending the chip card 20 back and forth. The deformation can be seen at an area designated by DF as an example.

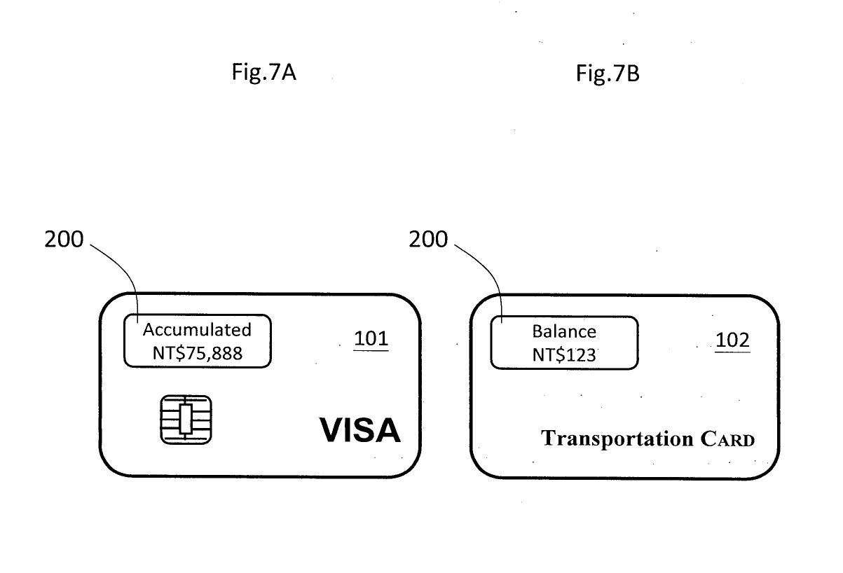

FIGS. 7A˜7B shows information displayed on a display unit of the card.

An updated information is displayed on the display unit 200 when the display unit 200 is energized. For example, FIG. 7A shows that the display unit 200 displays an accumulated amount of NT$75,888 for the visa card 101, which is the total amount swiped by the card holder in the latest time period for transaction payments, with the information, the card holder can well manage his budget plan. FIG. 7B shows that a balance of NT$123 available for the transportation card, with this information the card holder can well manage his following itinerary.

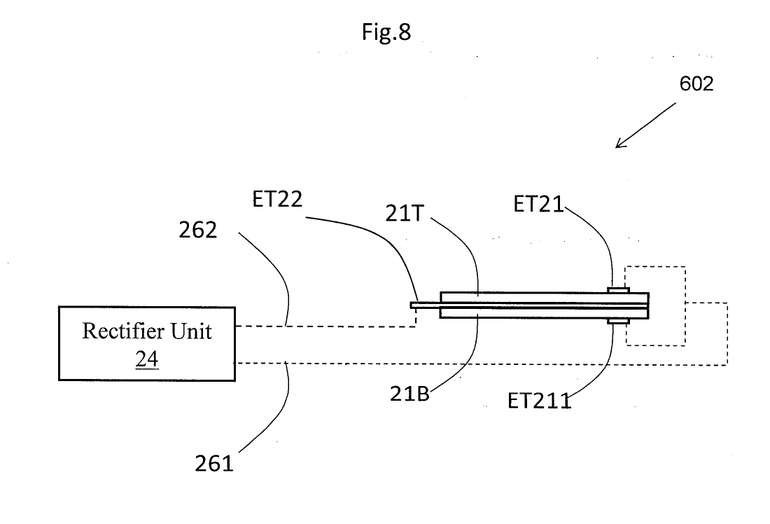

FIG. 8 shows a second self power unit according to the present invention.

FIG. 8 shows a second self power unit 602 which can be installed in a card 30. A rectifier unit 24 is used to convert alternating current to direct current for output. A first sheet of piezoelectric material 21T has a first polarization direction which causes an induced alternating current having a direction in relation to the bending direction. The first sheet of piezoelectric material 21T has a top electrode ET21 on top. A metal layer ET22 is configured under the first sheet of piezoelectric material 21T. A second sheet of piezoelectric material 21B has a second polarization direction opposite to the first polarization direction and is configured under the metal layer ET22. The second sheet of piezoelectric material 21B has a bottom electrode ET211 on bottom. The top electrode ET21 combining with the bottom electrode ET211 forms a first electrode and then electrically couples to a first end of a rectifier unit 24 through circuit 261. The metal layer ET22 contacts the bottom of the first sheet of piezoelectric material 21T and contacts the top of the second sheet of piezoelectric material 21B and functions as a second electrode to electrically couple to a second end of the rectifier unit 24 through circuit 262. Since the polarization direction for the first sheet of piezoelectric material 21T is opposite to that for the second piezoelectric material 21B, the induced current is always opposite with each other between the first sheet of piezoelectric material 21T and the second piezoelectric material 21B, therefore, when the combination of piezoelectric material 21T, 21B is bending back and forth, double electric energy is obtained to output, as compared to a power generator where a single piezoelectric material is used.

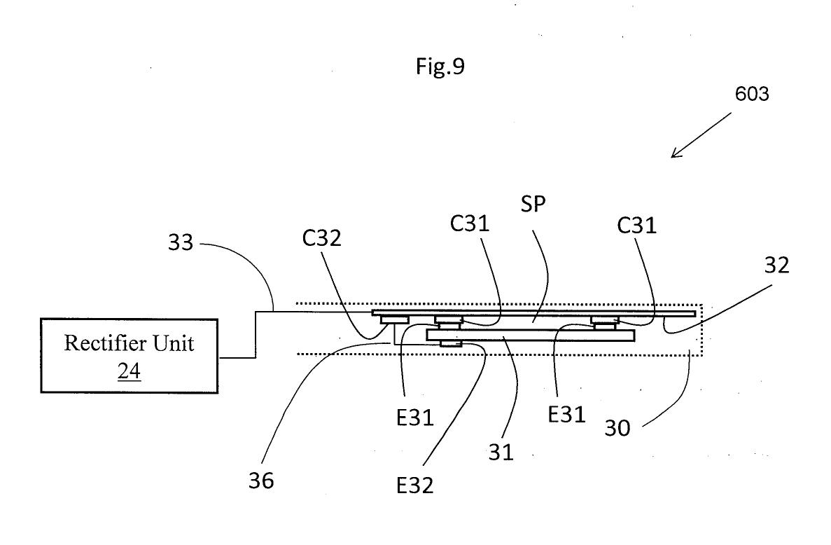

FIG. 9 shows a third self power unit according to the present invention.

FIG. 9 shows a third self power unit 603 which can be installed in a chip card 30. A rectifier unit 24 is used to convert alternating current to direct current for output. A circuit board 32 has a first electric contact C31 and a second electric contact C32. A sheet of piezoelectric material 31 has a top electrode E31 electrically coupling to the first electric contact C31. The piezoelectric material 31 has a bottom electrode E32 electrically coupling to the second electric contact C32 through circuit 36. A space SP is configured in between the circuit board 32 and the piezoelectric material 31 to provide a buffer area needed for the deformation of the piezoelectric material 31 when the piezoelectric material 31 is pressed.

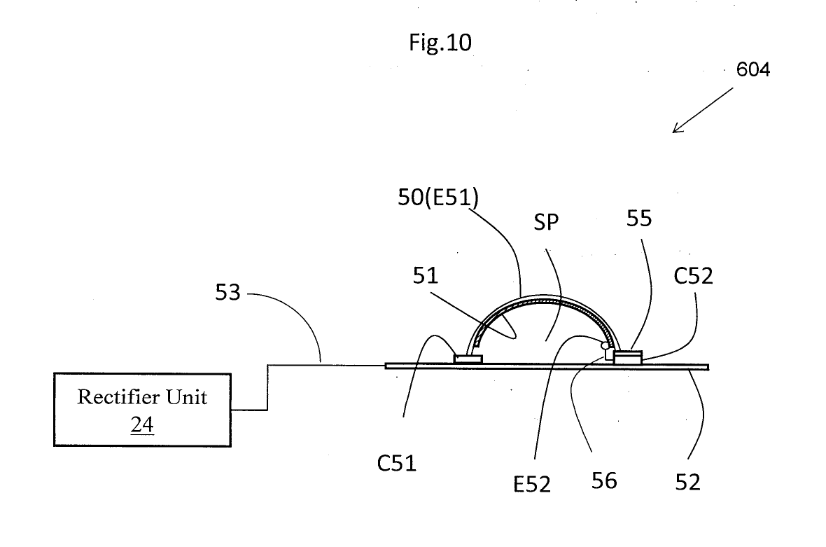

FIG. 10 shows a fourth self power unit according to the present invention.

FIG. 10 shows a fourth self power unit 604 which can be installed in a chip card 30. A rectifier unit 24 is used to convert alternating current to direct current for output. A depressable dome metal 50 is underlined with a sheet of piezoelectric material 51. A circuit board 52 has a first electric contact C51 and a second electric contact C52. A space SP is formed in between the depressable dome metal 51 and the circuit boar 52 to provide an area needed for the deformation of the depressable dome metal 51 when the depressable dome metal 51 is pressed down. The depressable dome metal 51 touches the top of the piezoelectric material 51 to function as a top electrode. The depressable dome metal 50 electrically couples to the first electric contact C51. The first electric contact C51 and the second electric contact C52 electrically couple to the rectifier unit 24 respectively. A second electrode E52 is configured on bottom of the piezoelectric material 51 and electrically couples to the second electric contact C52 through circuit 56. The first electric contact C51 and a second electric contact C52 electrically couple to the rectifier unit 24 respectively.

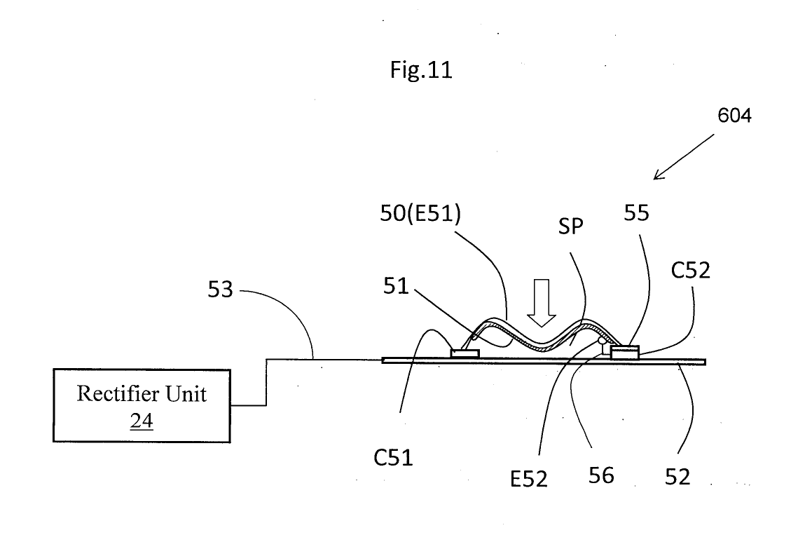

FIG. 11 shows a depressed status of the self power unit according to the present invention.

FIG. 11 shows a depressed status for the depressable dome metal 50 shown in FIG. 10. An alternating voltage arises between the first electric contact C51 and the second electric contact C52 when the depressable dome metal 50 combing the piezoelectric material 51 is deformed by depressing and releasing repeatedly.

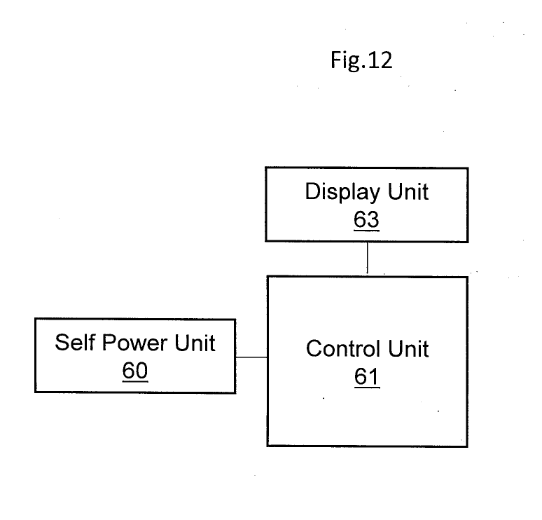

FIG. 12 shows a circuit block diagram for a first display system according to the present invention.

FIG. 12 shows a circuit block diagram for a first display system. A display unit 63 is used for displaying. A control unit 61 electrically couples to the display 63 for controlling the display unit 63. A self power unit 60 electrically couples to the control unit 61 for supplying electric power to the control unit 61.

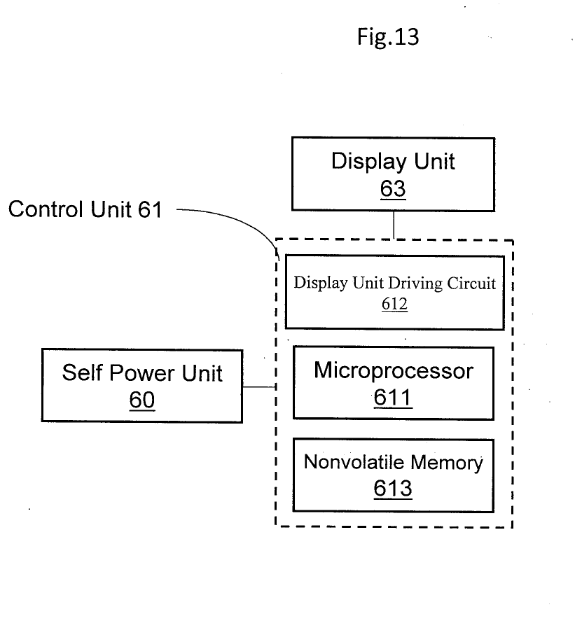

FIG. 13 shows a circuit block diagram for a second display system according to the present invention.

FIG. 13 shows a chip card display system similar to that shown in FIG. 12. the difference is that FIG. 13 shows one embodiment for the control unit 61 to include a display unit driving circuit 612, a microprocessor 611, and a nonvolatile memory. The display unit driving circuit 612 electrically couples to the display unit 63. The microprocessor 611 electrically couples to the driving circuit 612. The nonvolatile memory 613 such as an EEPROM electrically couples to the microprocessor 611.

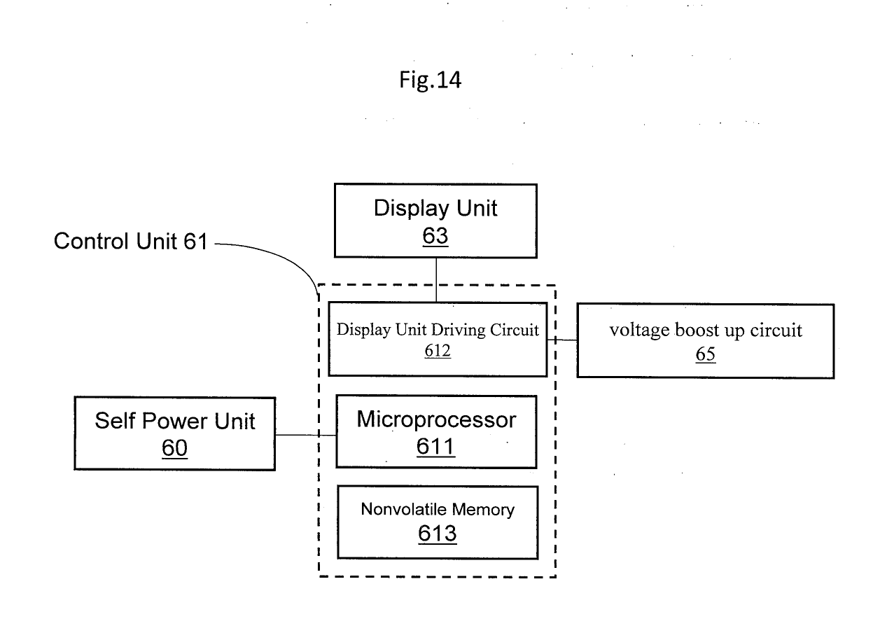

FIG. 14 shows a circuit block diagram for a third display system according to the present invention.

FIG. 14 shows a chip card display system as shown in FIG. 13, the difference is that FIG. 14 further includes: a boost up circuit 65 electrically coupling to the driving circuit 612 to raise the voltage to a level enough for triggering the display unit driving circuit 612, so that the display unit 63 can display the stored information.

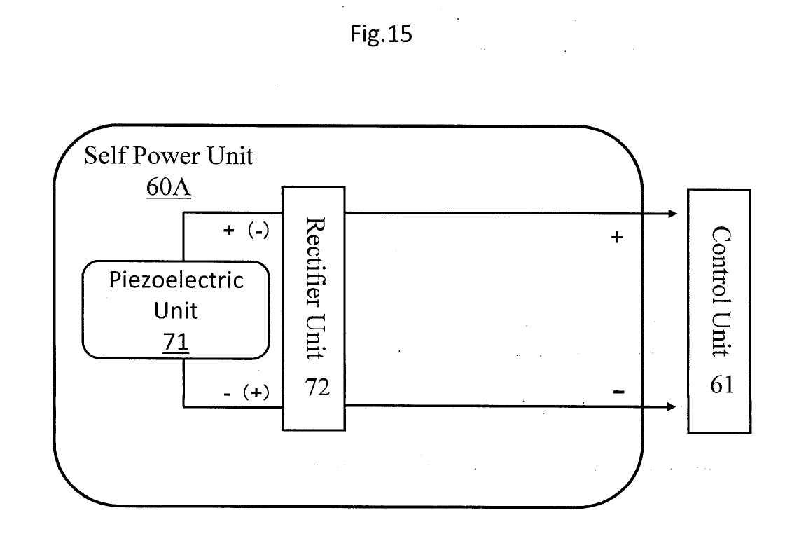

FIG. 15 shows a circuit block diagram for a first self power unit according to the present invention.

FIG. 15 shows a first self power unit 60A which can be installed in a chip card display system according to the present invention. A rectifier unit 72 has a first end electrically coupling to a piezoelectric unit 71, and has a second end electrically coupling to a control unit 61.

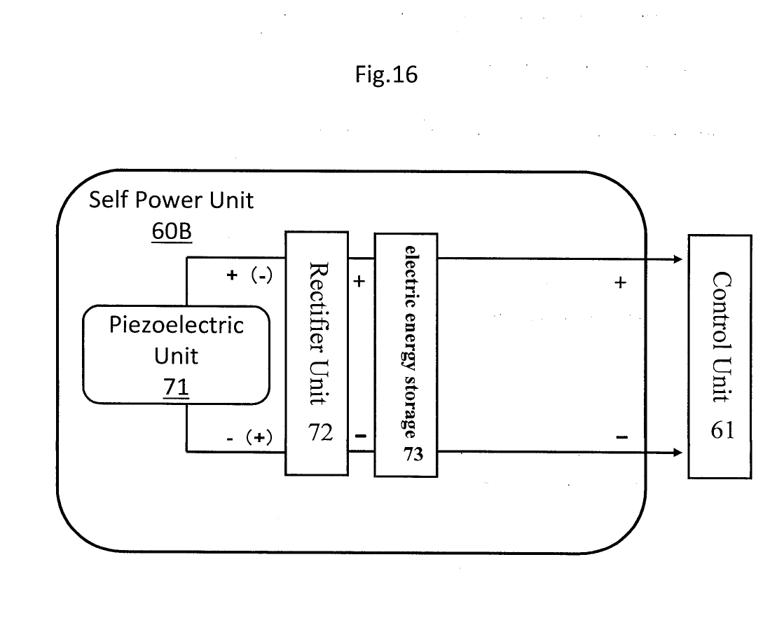

FIG. 16 shows a circuit block diagram for a second self power unit according to the present invention.

FIG. 16 shows a circuit block diagram for a second self power unit 60B which can be installed in a chip card display system according to the present invention. FIG. 16 is similar to that shown in FIG. 15, the difference is that FIG. 16 adds an electric energy storage 73 in between the rectifier unit 72 and the control unit 61. The electric energy storage 73 has a first end electrically coupling to the rectifier unit 72, and has a second end electrically coupling to the control unit 61 for storing the direct current electric energy generated from the rectifier unit 72.

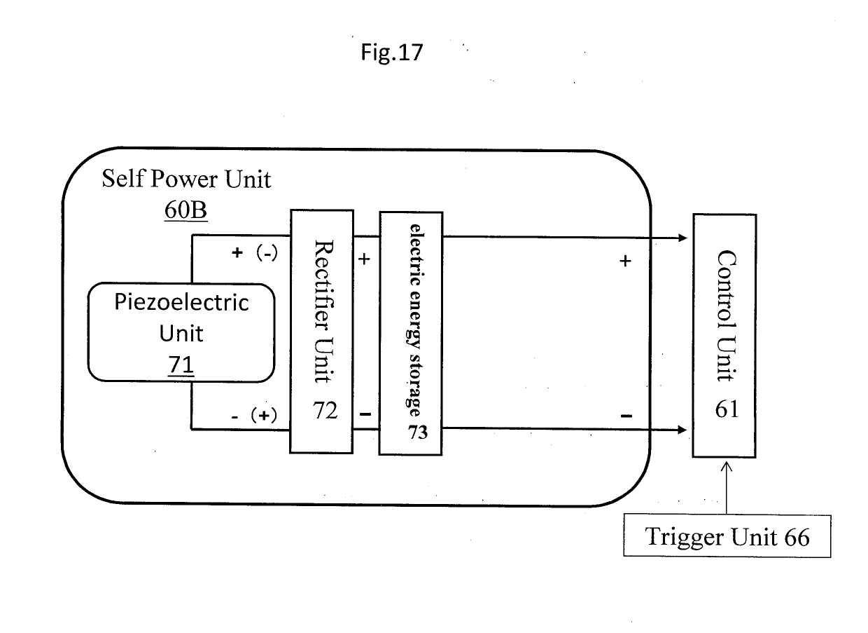

FIG. 17 shows a modified circuit to the second self power unit according to the present invention.

FIG. 17 shows a modified circuit to the second self power unit 60B. The difference is that FIG. 17 adds a trigger unit 66 which electrically couples to the control unit 61. The trigger unit 66 is used to trigger the display unit 200 to display. The trigger unit 66 is an exterior trigger unit such as a button trigger unit, a radio frequency (RF) trigger unit, or a chip card interface contact trigger unit.

The trigger unit 66 can be a button trigger unit to be depressed by human hand to trigger the display system to work. The trigger unit 66 can be a radio frequency (RF) trigger unit to receive a specific radio frequency to trigger the display system to work. The trigger unit 66 can be a chip card interface contact trigger unit to trigger the display system to work, the stored information displayed on the display unit 200 when the chip card is inserted into an exterior card reader.

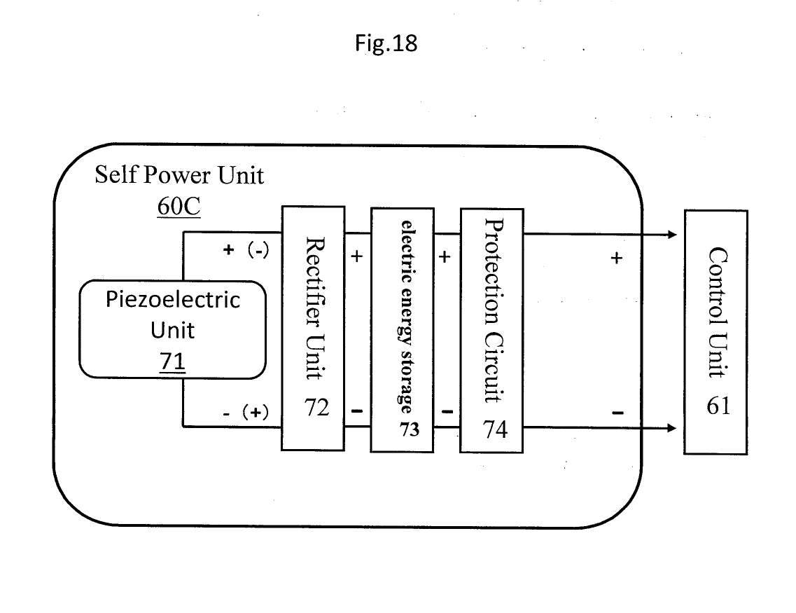

FIG. 18 shows a circuit block diagram for a third self power unit according to the present invention.

FIG. 18 shows a circuit block diagram for a third self power unit 60C. FIG. 18 is similar to that shown in FIG. 16; the difference is that FIG. 18 adds a protection circuit 74 in between the electric energy storage 73 and the control unit 61. The protection circuit 74 has a first end electrically coupling to the electric energy storage 73, and has a second end electrically coupling to the control unit 61. The protection circuit 74 is provided for avoiding over voltage which shall damage the system.

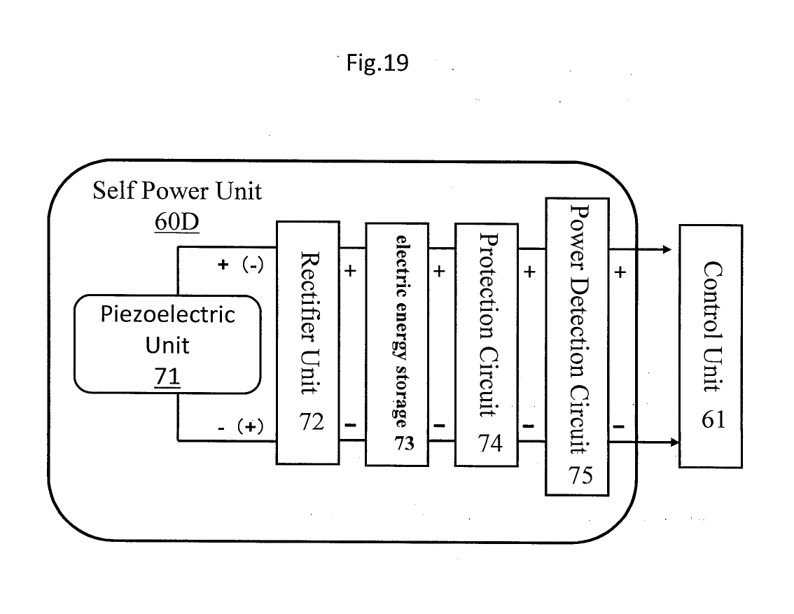

FIG. 19 shows a circuit block diagram for a fourth self power unit according to the present invention.

FIG. 19 shows a circuit block diagram for a fourth self power unit 60D. FIG. 19 is similar to that shown in FIG. 18, the difference is that FIG. 19 adds power detection circuit 75. The power detection circuit 75 has a first end electrically coupling to the protection circuit 74; and has a second end electrically coupling to the control unit 61. The power detection circuit 75 is provided for avoiding low voltage which shall bring down the system.

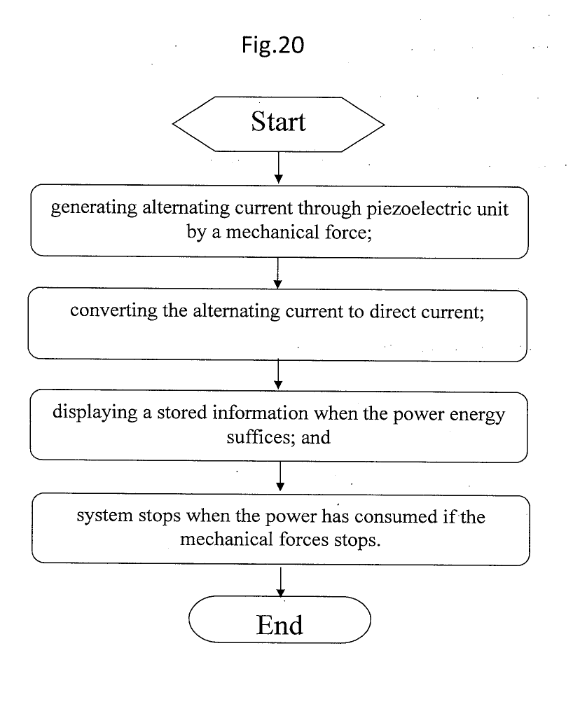

FIG. 20 shows a logic block diagram for a first chip card display system according to the present invention.

FIG. 20 shows the steps include:

(1) generating alternating current through piezoelectric unit by a mechanical force;
(2) converting the alternating current to direct current;
(3) displaying a stored information when the power energy suffices; and
(4) system stops when the power has consumed if the mechanical forces stops.

The mechanical force herein can be manpower, or a vibration frequency resonant to the piezoelectric material produced from outside sources.

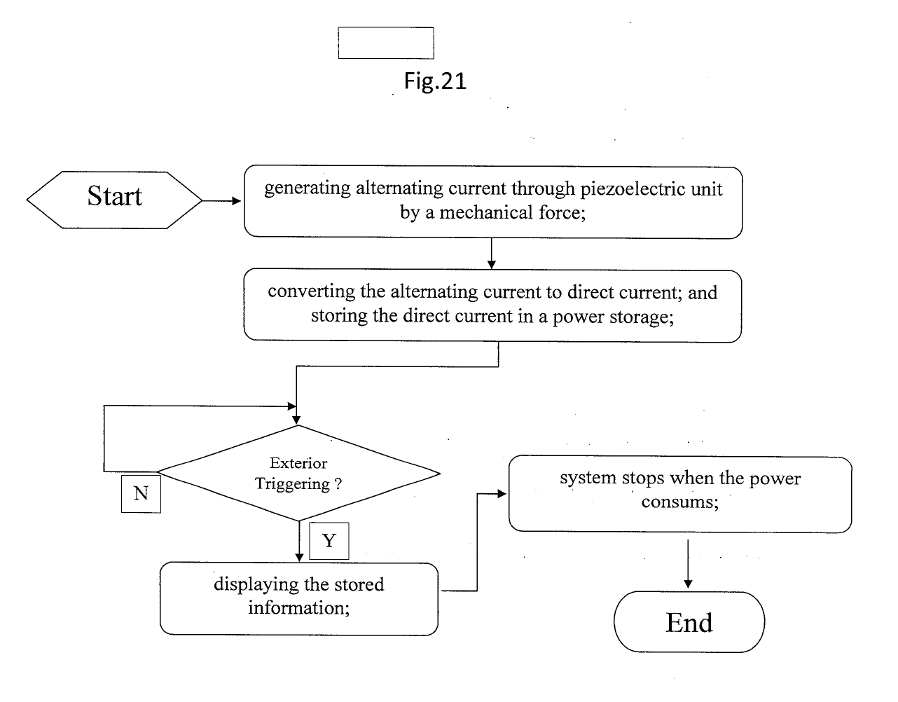

FIG. 21 shows a logic block diagram for a second chip card display system according to the present invention.

FIG. 21 shows the steps include:

(1) generating alternating current through piezoelectric unit by a mechanical force;
(2) converting the alternating current to direct current; and storing the direct current in a power storage;
(3) exterior triggering?
(4) if yes, displaying the stored information; and
(5) system stops when the power consumes.

The exterior triggering can be push button triggering, radio frequency (RF) triggering, or chip card interface contact triggering.

While several embodiments have been described by way of example, it will be apparent to those skilled in the art that various modifications may be made without departing from the spirit of the present invention. Such modifications are all within the scope of the present invention, as defined by the appended claims.

1. A chip card display system, comprising:
a display unit, having a display surface exposed out of the chip card for displaying;
a rectifier, converting alternating current to direct current for output; and
a sheet of piezoelectric material, having a top electrode electrically coupling to a first end of the rectifier; and having a bottom electrode electrically coupling to a second end of the rectifier.

2. A chip card display system as claimed in claim 1, further comprising:
a control unit, having a first end electrically coupling to the display unit; and having a second end electrically coupling to the rectifier.

3. A chip card display system as claimed in claim 1, wherein an alternating voltage arises between the top electrode and the bottom electrode when the piezoelectric material is deformed.

4. A chip card display system as claimed in claim 1, wherein an information stored in the chip card being displayed when the system is energized.

5. A chip card display system, comprising:
a rectifier unit, converting alternating current to direct current for output;
a first sheet of piezoelectric material, having a first polarization direction and having a top electrode;
a metal layer, configured on bottom of the first sheet of piezoelectric material;
a second piezoelectric material, having a second polarization direction and having a bottom electrode; configured on bottom of the metal layer; the top electrode connecting with the bottom electrode and electrically coupling to a first end of the rectifier unit; and wherein
the metal layer electrically coupling to a second end of the rectifier unit.

6. A chip card display system, comprising:
a rectifier unit, converting alternating current to direct current for output; and
a circuit board, having a first electric contact and a second electric contact;
a sheet of piezoelectric material, having a top electrode electrically coupling to the first electric contact; and having a bottom electrode electrically coupling to the second electric contact;
a space, configured in between the circuit board and the piezoelectric material; and wherein
the first electric contact and the second electric contact are electrically coupling to the rectifier unit.

7. A chip card display system, comprising:
a rectifier unit, converting alternating current to direct current for output;
a depressable dome metal;
a sheet of piezoelectric material, configured under the bottom surface of the dome metal;
a circuit board, having a first electric contact and a second electric contact; and
a space, configured in between the dome metal and the circuit board; wherein
the dome metal electrically coupling to the first electric contact; and the first electric contact and the second electric contact electrically coupling to the rectifier unit.

8. A chip card display system as claimed in claim 7, wherein an alternating voltage arises between the first electric contact and the second electric contact when the dome metal combining with the piezoelectric material is depressed.

9. A chip card display system, comprising:
a display unit;
a control unit, electrically coupling to the display unit; and
a self power unit, electrically coupling to the control unit.

10. A chip card display system as claimed in claim 9, wherein the control unit further comprising:
a display unit driving circuit, electrically coupling to the display unit;
a microprocessor, electrically coupling to the driving circuit; and
a nonvolatile memory, electrically coupling to the microprocessor.

11. A chip card display system as claimed in claim 10, further comprising:
a boost up circuit, electrically coupling to the driving circuit.

12. A chip card display system as claimed in claim 9, wherein the self power unit further comprising:
a piezoelectric unit; and
a rectifier unit, having a first end electrically coupling to the piezoelectric unit; and
having a second end electrically coupling to the control unit.

13. A chip card display system as claimed in claim 12, further comprising:
an electric energy storage, having a first end electrically coupling to the rectifier unit;
and having a second end electrically coupling to the control unit.

14. A chip card display system as claimed in claim 13, wherein the electric energy storage is a secondary battery, a capacitor, or a super capacitor.

15. A chip card display system as claimed in claim 13, further comprising:
a trigger unit, electrically coupling to the control unit.

16. A chip card display system as claimed in claim 15, wherein the trigger unit is a button trigger unit, a radio frequency (RF) trigger unit, or a chip card interface contact trigger unit.

17. A chip card display system as claimed in claim 13, further comprising:
a protection circuit, having a first end electrically coupling to the electric energy storage; and
having a second end electrically coupling to the control unit.

18. A chip card display system as claimed in claim 17, further comprising:
a power detection circuit, having a first end electrically coupling to the protection circuit; and
having a second end electrically coupling to the control unit.

19. A chip card display system, having a display method comprising:
(1) generating alternating current through piezoelectric unit by a mechanical force;
(2) converting the alternating current to direct current; and
(3) displaying a stored information when the power suffices.

20. A chip card display system as claim in claim 19, wherein the mechanical force is a manpower, or a vibration frequency resonant to the piezoelectric material.

21. A chip card display system, having a display method comprising:
(1) generating alternating current through piezoelectric unit by a mechanical force;
(2) converting the alternating current to direct current; and storing the direct current energy in an electric energy storage;
(3) exterior triggering? and
(4) if yes, displaying the stored information.

22. A chip card display system as claim in claim 21, wherein the exterior triggering is a push button triggering, a radio frequency (RF) triggering, or a chip card interface contact triggering.
